(19) United States
(12) Patent Application Publication
(10) Pub. No.: US 2021/0197263 A1
(43) Pub. Date: Jul. 1, 2021

(54) BUILD MATERIAL FORMATION

(71) Applicant: HEWLETT-PACKARD DEVELOPMENT COMPANY, L.P., Houston, TX (US)

(72) Inventors: Timothy L. WEBER, Corvallis, OR (US); James MCKINNELL, Corvallis, OR (US); David A. CHAMPION, Corvallis, OR (US); Mohammed S. SHAARAWI, Corvallis, OR (US)

(73) Assignee: HEWLETT-PACKARD DEVELOPMENT COMPANY, L.P., Houston, TX (US)

(21) Appl. No.: 16/075,030

(22) PCT Filed: Apr. 21, 2017
(86) PCT No.: PCT/US2017/028796

§ 371 Date: Aug. 2, 2018

(51) Int. Cl. B22F 9/04; B22F 1/00; B33Y 70/00; B22F 9/14

(52) U.S. Cl. CPC B22F 9/04; B22F 1/0085; B33Y 70/00; B22F 1/0048; B22F 9/14; B22F 2202/11; B22F 2201/02; B22F 2201/10; B22F 2201/013; B22F 2201/04; B22F 2009/046

(57) ABSTRACT

A device for forming spherical particles may include a receiving chamber having a heating portion and a cooling portion. Wire segments may travel in a free fall through the receiving chamber. While falling through the heating portion, wire segments may be heated to form spherical particles in response to exposure to microwave electromagnetic radiation. While falling through the cooling portion, formed spherical particles cool.

### BACKGROUND

Manufacturing of particulate build materials, such as to be used to form layers of a build material in three-dimensional (3D) printing, may comprise forming particles having a spherical shape. Methods for forming such particles may include plasma atomization and gas atomization, by way of example.

### BRIEF DESCRIPTION OF THE DRAWINGS

Various examples will be described below by referring to the following figures.

FIG. 1 is a schematic diagram of an example system for forming spherical particles;

FIG. 2 is a flowchart of an example method for forming spherical particles;

FIG. 3 is a schematic diagram of another example system for forming spherical particles comprising a wire feed cutter; and

FIG. 4 is a flowchart of an example method for forming spherical particles using two heating sources.

Reference is made in the following detailed description to the accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

At times, there may be a desire to form spherical-type particles. For example, 3D printing may process layers of build material comprising spherical particles. One type of 3D printing, for instance, may form layers of a build material on a build platform. Portions of each formed layer may be selectively solidified, to form a layer of a 3D object. In one example, a 3D printer may selectively deposit a print agent liquid as part of the selective solidification process. A print agent liquid may be deposited at desired locations in the build material. The build material/print agent liquid combination may be exposed to electromagnetic radiation (EMR). At some portions of the build material, such as in response to the print agent liquid and the EMR, particles of the power bed may fuse together. A process of layering particles to form a layer of build material, depositing print agent liquids, and exposing the build material to EMR may be repeated in successive layers to form a three-dimensional object. At times, build materials having particles with relatively large size variance (e.g., in diameter) may be undesirable, as size variances may lead to weaknesses in a printed object, such as due, for example, to air gaps that may form in spaces left by differently sized build material particles. There may be a desire, therefore, to use build material particles having a substantially uniform size.

In one example, particles that make up a build material may be formed using a process that creates spherical particles of different sizes. In the context of the present disclosure, build material particles are referred to as “particles,” “spheres,” or “spherical particles” for simplicity. For instance, in one case, it may be desirable to have a build material comprising metallic spherical particles, such as to form a metallic three-dimensional object. By way of example, spherical particles may comprise a metal or metalloid and may be desirable for 3D printing three-dimensional metallic forms. A number of processes may exist to form spherical particles comprising a metal or a metalloid. Some such processes may include feeding wire feed into a chamber in which the wire feed is exposed to a heat source, liquefying wire feed. Spherical droplets of different sizes form and drop through the chamber, and are subsequently cooled. Because some methods may rely on a combination of gravity and surface tension of liquefying wire feed in the formation of spherical particles, formed spherical particles may be of different sizes rather than having a substantially uniform size. Spherical particles that are formed using processes that yield particles of different sizes may have to be sorted and grouped according to size subsequent to particle formation. As shall be shown, at times, such sorting and grouping may be undesirable.

For example, producing differently sized spherical particles may be undesirable because it may lead to excess or undesirable amounts of particles of a particular size (e.g., 20 μm particles, at times when 10 μm particles are desired). Processes that produce differently sized particles may also lead to spherical particles of a size that may be unsuitable for a particular build material. Processes that form differently sized particles can also encounter space-related limitations. For example, in powder-based 3D printing systems if the size of particles is not substantially uniform, particle filtering and grouping mechanisms and separate particle reception mechanisms may be warranted for each particle size grouping. Inclusion of particle filtering and grouping mechanisms and multiple particle reception mechanisms in a build material processing device may lead, in turn, to larger build material processing devices than may be desired. For at least these additional reasons, there may be a desire, therefore, for a process and apparatus for forming build material particles such that the formed spherical particles have a substantially uniform size.

In one case, for example, spherical particles of a substantially uniform size may be formed using pre-cut wire segments. In one example, pre-cut wire segments may have a diameter of less than approximately 100 μm (assuming, of course, round wire; other types of wire are also contemplated by the present description). The pre-cut wire segments may have a cut ratio of approximately 2:1 of wire segment length to wire segment diameter. Thus, in one case, 15 μm diameter wire segments may have an approximately 30 μm length. And the wire segments may be used to form spherical particles having a substantially uniform size. The process of forming the spherical particles may comprise allowing the wire segments to travel in a free fall (such as induced by gravity) and be heated above the melting point of the wire segments, while in free fall. A source of electromagnetic radiation (EMR) in the microwave spectrum (e.g., having wavelengths between approximately 1 m and approximately 1 mm, and having frequencies between 300 MHz and 300 GHz) may be used to cause the wire segments to transition to a liquid phase.

As shall be discussed in further detail hereinafter, in one example, it may be possible to heat wire segments using microwave EMR without necessarily having large heat retaining walls. For example, the melting point of iron can range from about 1100 to about 1593 degrees Celsius, depending on a particular form of iron. As such, a traditional heating mechanism (e.g., a heating element through which current is pulsed to generate heat) may include wall structures multiple centimeters thick, for example. It may be desirable, therefore, to perform heating of wire segments using wall structures that are thinner than what might be used in a traditional heating chamber. In another example, wire segments may be heated using a traditional heating mechanism to reach a temperature below a melting point of the wire segments. Subsequently, a pulse of EMR in the microwave spectrum may raise the temperature of the heated wire segments above the melting point. The heated wire segments may transition to a liquid phase and make take a spherical form. In the following paragraphs, example devices and methods for forming spherical particles are discussed by way of example, but not limitation.

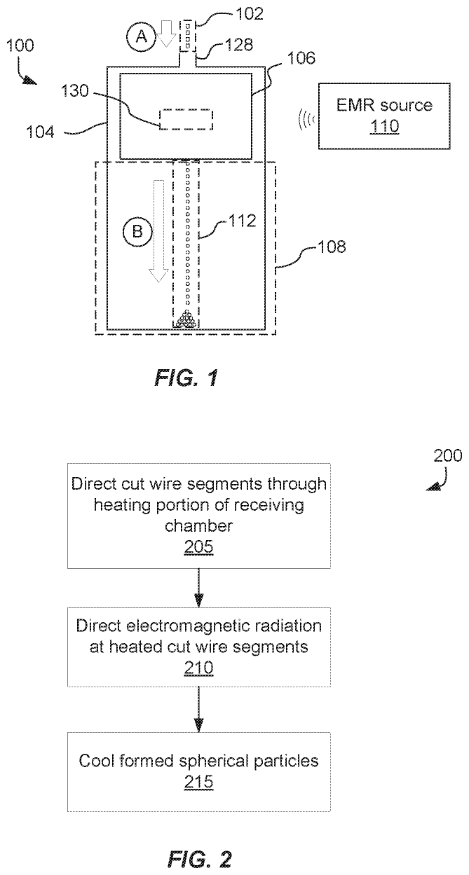

FIG. 1 illustrates a sample system 100 for forming spherical particles, for example, for use as a 3D printing build material. Example system 100 for forming particles may comprise a receiving chamber 104. Receiving chamber 104 may be capable of receiving wire segments 102 via an inlet 128, such as is illustrated by arrow A. Receiving chamber 104 may be arranged in a cavity in a larger device through which wire segments 102 may travel. Receiving chamber 104 may comprise a heating portion 106 and a cooling portion 108. Spherical particles 112 may be formed by heating wire segments 102 above a melting point as they fall in a free fall through heating portion 106, as indicated by arrow B. As the heated wire segments 102 transition to a liquid phase, they may take a spherical form. The liquid wire segments 102 may be solidified by bringing their temperature back down below the melting point, such as in cooling portion 108. The atmosphere in heating portion 106 and cooling portion 108 may be controlled. For instance, one or more gasses may be present to facilitate heating and cooling. It is noted that though the present application uses the terms ‘sphere’ and ‘spherical’ to describe the form that melted and cooled wire segments may take, certain imperfections may still be present. Thus, as used herein, formed spheres are not necessarily perfectly spherical, but may have imperfections (e.g., surface imperfections).

In one implementation, and as shall be discussed in greater detail hereinafter, heating portion 106 may comprise one or more sources of heat or EMR. For instance, as shown by EMR source 110, a source of electromagnetic radiation, such as EMR source 110 may be capable of emitting microwave EMR towards a portion of receiving chamber 104. Thus, in one implementation, an EMR source 110 may be used as a sole heating source for example system 100. In another implementation, a convection, conduction, or induction-type heating mechanism may be used in addition to EMR source 110, such as arranged within heating portion 106.

As mentioned above, in one example, wire segments in free fall may be heated to reach a temperature above a melting point for the wire segments. After reaching the melting point, the wire segments will transition to a liquid phase, at which point the wire segments take a spherical shape. Spherical particles may be formed due to the surface area-to-volume ratio and surface tension of the liquefied wire segments. Liquefied wire segments (having a spherical shape) may be cooled (and thus solidify) as a temperature thereof decreases during free fall. By using wire segments having substantially uniform size, it may be possible to form spherical particles having substantially uniform diameter.

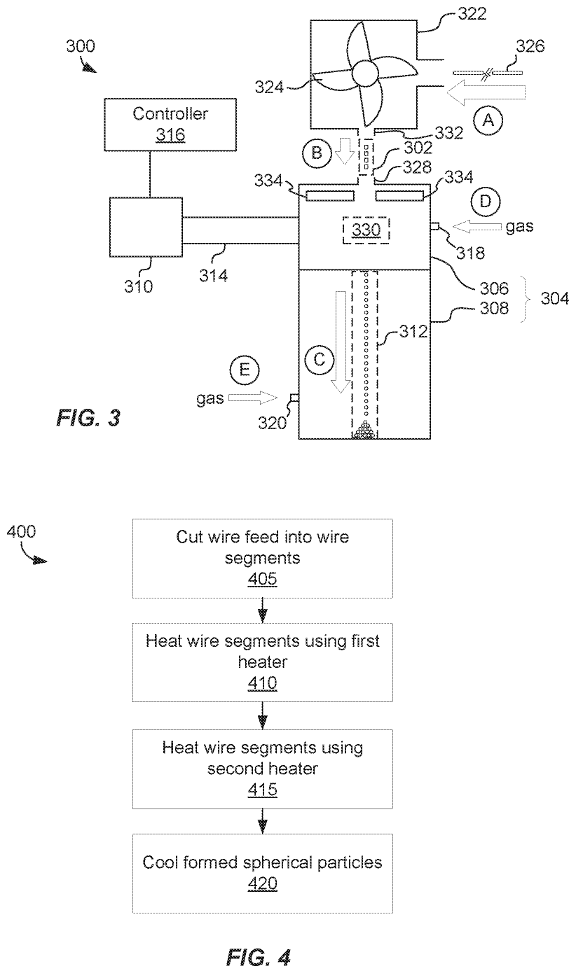

Thus, returning to FIG. 1, receiving chamber 104 may receive wire segments 102, such as illustrated with arrow A. By way of example, and consistent with block 205 of example method 200 in FIG. 2, wire segments 102 may be directed, such as via inlet 128, through heating portion 106 of receiving chamber 104. In one example, wire segments 102 may be formed by cutting a wire feed into uniformly-sized segments. As noted above, in one example, the wire feed may have a diameter of less than 100 μm. In another example, the diameter of the wire feed may be less than 15 μm. The cut ratio may be approximately less than 2:1 of length to diameter.

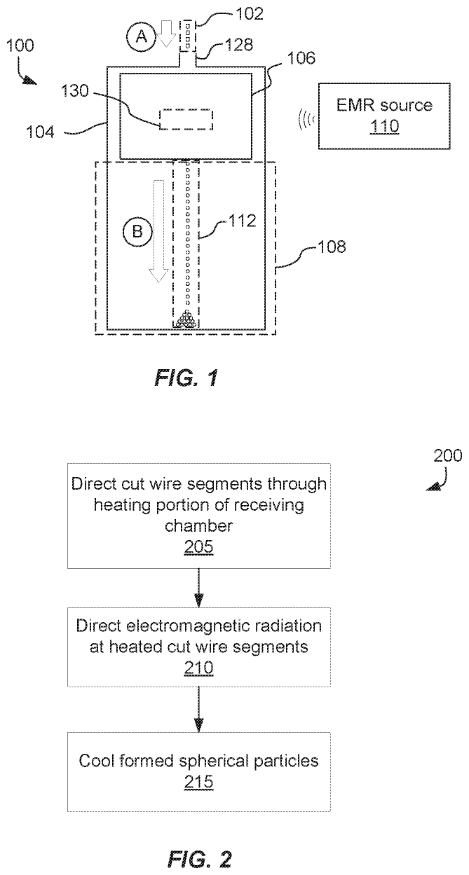

Wire segments 102 may be cut by a cutting mechanism prior to feeding wire segments 102, by free fall, through the receiving chamber 104, as shall be discussed in further detail hereinafter in reference to FIG. 3. In another implementation, wire segments 102 may be fed into a device or system having already been pre-cut.

Wire segments 102 that enter receiving chamber 104 may fall through heating portion 106. In heating portion 106, wire segments 102 may be heated to temperatures above a melting point of the wire segments. In one example, walls structures of the receiving chamber 104 may be insulated or reinforced, such as to retain heat (e.g., for conservation of energy, keeping heat inside chamber, etc.).

Receiving chamber 104 may be sized so as to allow heating and cooling of wire segments 102 and spherical particles 112, respectively, while travelling through receiving chamber 104 in free fall. In one case, dimensions of receiving chamber 104 may depend on a wire segment material being melted/cooled. For example, wire segments 102 comprising materials with high melting points may reach melting points more slowly and may thus warrant more time in free fall to transition from solid to liquid and back to solid. Thus, receiving chambers for such materials may be larger. Conversely, wire segments 102 comprising materials with comparatively lower melting points may reach melting points more quickly and may thus be in free fall for less time between the transition from solid to liquid and back to solid. Thus, receiving chambers for such materials may be comparatively smaller than that of the high melting point materials. In one example, a particular melting time for wire segments 102 may be determined empirically.

A size of receiving chamber 104 may also depend on sources of heating and cooling. For example, in one case, a source for heat in heating portion 106 (e.g., via convection, conduction, induction, or radiation, for example) may be capable of liquefying wire segments 102 in a given time (e.g., such as determined empirically). A size of receiving chamber 104 may be determined based on a time to liquefy wire segments 102 and a rate of free-fall of wire segments 102 through receiving chamber 104. Accordingly, a size of receiving chamber 104 may be based on a velocity of wire segments 102 travelling in a free fall (e.g., at approximately x m/s, assuming, of course, a constant rate of travel for simplicity) and a time for a temperature of wire segments 102 to increase above a melting point (e.g., in seconds), such as based on a particular heating source. Using the rate of travel of the wire segment (e.g., x m/s) and the time to liquefy (e.g., y seconds), it may be possible to solve for a minimum height for heating portion 106 (e.g., x m/sec·y sec=z m). Similar determinations may be performed to determine a minimum height of cooling portion 108.

Yet another factor to consider in determining size of receiving chamber 104 may comprise an atmosphere of receiving chamber 104. Indeed, in one example, receiving chamber 104 may comprise a controlled atmosphere. For example, a gas may be present in heating portion 106 and cooling portion 108 that may facilitate heating and cooling, respectively, of wire segments 102. Again, heating and cooling time determinations may be determined experimentally, by way of example. Different gasses may be used for different materials of wire segments 102. In one example, receiving chamber 104 may comprise a controlled atmosphere, which may facilitate heating and cooling of wire segments 102. Among other things, controlling an atmosphere when forming particles may be desirable such as to obtain desired purity of spherical particles 112 (e.g., to avoid unintentional introduction of impurities present in the atmosphere to particles that could potentially affect structural integrity). Controlling an atmosphere may also ensure proper heating and cooling conditions, such as to ensure sufficient times for uniform melting and cooling.

In one case, a controlled atmosphere of receiving chamber 104 may comprise different gasses. For example, a gaseous reducing agent, referred to herein as a reducing gas, may be used in heating portion 106. A reducing gas or an inert gas may facilitate heating of wire segments 102, for example. Example reducing gas may include forming gas, CO or H₂; inert gasses may include mixtures of argon, helium, or nitrogen (in some cases), without limitation. A particular gas may be favored for heating certain materials. For example, in one case, an example forming gas may comprise less than approximately 5% hydrogen with the remainder comprising nitrogen (such as to reduce risk of flammability). In another case, pure H₂ may be used. In yet another case, carbon monoxide may be used for some metals (e.g., cobalt and iron-based alloys, such as carbon steels). Materials for which forming gas may be used may include stainless steels and Inconels (nickel-chromium-based alloys), without limitation. Titanium and aluminum alloys may not be good candidates for use with nitrogen and hydrogen; instead, argon or helium may be used. Further, a quenching gas may be used in cooling portion 108. A quenching gas may facilitate cooling, for example. Example quenching gasses may include helium and argon, without limitation. Nitrogen and hydrogen or forming gas may also be used. Similar to the case of reducing gas, a particular quenching gas may be favored for cooling certain materials. For example, argon and helium may be used for most metals. Nitrogen and hydrogen may not be good candidates for use with titanium alloys. And nitrogen may also not be a good candidate for aluminum alloys. Of course, the foregoing is presented merely by way of illustration and is not to be taken in a limiting sense.

It is noted that at times, fewer than two gasses may be used in receiving chamber 104. Additionally, though, in some implementations a partition may be used as a separation for gasses in heating portion 106 and cooling portion 108. However, by using EMR source 110, heat loss in heating portion 106 may be less of a concern. As such, for example, one or more gasses in heating portion 106 may be able to travel down into cooling portion 108 without necessarily increasing an amount of time for wire segments 102 to transition to a liquid phase.

Returning to the discussion of size of receiving chamber 104, it is noted that at times, a size of receiving chamber 104 may be constrained by a size of a device in which receiving chamber 104 may be arranged. In such cases, rather than determining a chamber size, it may be possible to determine a heating source and heating intensity to induce a transition from solid to liquid phase for wire segments 102 in a heating portion 106 and determine a cooling mechanism to induce a transition from a liquid phase to a solid phase for spherical particles 112 in cooling portion 108. Such a determination may comprise using a rate free fall of wire segments (e.g., x m/s) and dimensions of receiving chamber 104 (e.g., heating portion comprising y meters and cooling portion comprising z meters for a total height of y+z meters) and solving for a time available for wire segments 102 to transition from a solid to a liquid, and a time available for spherical particles 112 to transition from a liquid to a solid

$$( e . g . , time t = ( ym \div x \frac{m}{s e c} ) + ( x \frac{m}{s e c} \div zm ) ) .$$

The determined time available values may be used to determine a particular heating source and a particular gas reducing agent and quenching gas, by way of illustration. In one example case, consistent with the foregoing, a heating portion 106 may be approximately 5 cm (e.g., approximately 2 in.) in height. And a cooling portion 108 may be approximately 15 cm (e.g., approximately 6 in.) in height. Of course, these dimensions are merely illustrative and are not to be taken in a limiting sense.

Receiving chamber 104 may also comprise a collection area to collect solidified spherical particles 112, as illustrated by spherical particles 112 stacked at the bottom of receiving chamber 104. In one example, cooled or cooling spherical particles 112 may be directed to a separate chamber for collection. For instance, spherical particles 112 may be cooled to a temperature below melting (e.g., where solid, but still hot) in cooling portion 108, and may be directed to a different portion of a device or system for further cooling, collection, etc.

As noted above, receiving chamber 104 may be divided into a heating portion 106 and a cooling portion 108. In some cases, wire segments 102 may be heated in heating portion 106 using a traditional heating source, such as a convection, conduction, or induction heat source. In one case, a source of EMR may be used to cause wire segments 102 to be heated above a melting point thereof. By way of illustration, and consistent with block 210 of example method 200 in FIG. 2, EMR may be directed at wire segments 102 in heating portion 106. For instance, a source of microwave EMR, such as EMR source 110, may be used. EMR source 110 may be focused, for example, on a particular subpart or region within receiving chamber 104, as illustrated by EMR exposure region 130, and may heat falling wire segments 102 above a melting point while wire segments 102 are located within EMR exposure region 130.

In one case, more than one heating source may be used in combination to heat wire segments 102. For example, a typical convection, conduction, or induction heat source (such as represented by the rectangle indicating heating portion 106) may heat wire segments 102 to a first temperature. And EMR in the microwave spectrum, such as from EMR source 110, may be directed at the heated wire segments 102 to cause wire segments 102 to reach a second temperature, greater than the first temperature, in EMR exposure region 130. The heated wire segments 102 may liquefy and form spheres. As heated wire segments 102 leave EMR exposure region 130, the formed spherical particles 112 may cool and re-solidify in a spherical shape. In one implementation, solidification of spherical particles 112 may occur in cooling portion 108 of receiving chamber 104, such as consistent with block 215 of example method 200 of FIG. 2.

FIG. 3 illustrates an example system 300 for forming spherical particles comprising a wire cutter 322 to cut wire feed 326 into wire segments 302. Wire feed 326 may be fed into wire cutter 322 as illustrated by arrow A. It is noted that wire feed 326 is illustrated with broken lines to indicate that a length of wire feed is not to be constrained by the drawings. At times, for example, it may be desirable to cut wire segments 302 near heating portion 306 of example system 300, as opposed to using wire segments (e.g., wire segments 102 in FIG. 1) that may have been cut elsewhere. For instance, cutting wire feed 326 in proximity to heating portion 306 may provide adaptability, such as allowing the formation of particles of varying diameters in controlled numbers, such as based on user input. Example wire feed materials may include a number of metals and metalloids, without limitation. By way of illustration, Inconel-based alloys may be suitable wire feeds. In another material, stainless steel alloys may be suitable. For instance, a chromium-nickel-copper-based stainless steel may work in one case (e.g., SS 17-4PH). In another case, a chromium-nickel-based stainless steel comprising molybdenum may form a suitable wire feed (e.g., SS 316). The foregoing examples are presented by way of illustration and should not be taken in a limiting sense. Indeed, a number of possible metals and metalloids may be capable of being segmented and melted to form spherical particles, such as part of a building material.

Cutter 322 comprises a mechanism to divide wire feed 326 into segments, such as wire segments 302. In one example, cutter 322 may comprise a rotating cutter mounted on an axle and having radially mounted cutting blades 324 to cut wire feed 326 into wire segments 302. Cutting blades 324 of cutter 322 may comprise ceramic cutting heads, such as having zirconia (e.g., zirconia carbide) or Tungsten (WC), or diamond cutting heads by way of illustration. Cutter 322 may comprise a cutter outlet 332 through which cut wire segments 302 may fall, such as towards receiving chamber 304, as illustrated by arrow B.

As shall be described, in some ways, receiving chamber 304 may be similar to receiving chamber 104, described above. For instance, receiving chamber 304 comprises a heating portion 306 and a cooling portion 308. Receiving chamber 304 may comprise one or more inlets (e.g., inlets 318 and 320) in order to control the atmosphere within receiving chamber 304, such as by allowing the introduction of gasses. In one example, more than one gas may be introduced into receiving chamber 304. For instance, a reducing or inert gas (e.g., argon/hydrogen blend, nitrogen/hydrogen blend, H₂) may be used in a heating portion 306 of receiving chamber 304. The reducing gas may facilitate heating of wire segments 302 by way of example. A reducing gas may be introduced into heating portion 306 via inlet 318, as indicated by arrow D. And a quenching gas (e.g., He, H₂) may be used in a cooling portion 308 of receiving chamber 304. For instance, a reducing gas may be introduced into cooling portion 308 via inlet 320, as indicated by arrow E. In one case, gasses may be selected based on a particular material of wire feed 326. For instance, as described above, some materials, such as metals and metalloids, may interact more favorably with particular gasses (e.g., a particular subset of gasses).

In one implementation, heating portion 306 of receiving chamber 304 may comprise heating elements 334 to increase a temperature within heating portion 306. For example, as discussed above, heating elements 334 in heating portion 306 may raise a temperature of wire segments 302 so as to be greater than a melting point of materials making up wire segments 302. In another implementation, heating elements 334 in the heating portion 306 may raise a temperature of wire segments 302 to a point below the melting point of the material making up wire segments 302. Wire segments 322 may be heated subsequently using a form of EMR, such as microwave EMR, to raise a temperature of wire segments 302 above the melting point. Thus, as described in regards to example system 100 of FIG. 1, one example heating portion may use EMR source 110. And in example system 300 of FIG. 3, one example heating portion may use both heating elements 334 and EMR source 310.

In an example using EMR, a wave guide 314 may be arranged with respect to heating portion 306 of receiving chamber 304 to allow EMR to leave wave guide 314 and enter heating portion 306 of receiving chamber 302. Wave guide 314 may direct EMR to a desired region of heating portion 306, as indicated by EMR exposure region 330. It may be, for example, that wave guide 314 may enable focused transmission of EMR to EMR exposure region 330. Thus, as discussed above, wire segments 302 may traverse heating portion 306 in a free fall, may be heated to a temperature below a melting point (e.g., such as by heating elements 334), may enter EMR exposure region 330 and may be heated to a temperature above the melting point, such as to transition to a liquid phase. The liquefied wire segments 302 may begin cooling upon leaving EMR exposure region 330 and may continue to fall to and through a cooling portion 308 of receiving chamber 304.

In one example, an EMR source 310 may be in electrical communication with a controller or processor (referred to as a controller 316 for simplicity). Controller 316 may execute instructions (e.g., fetched from a memory) and transmit signals to EMR source 310 for the transmission of microwave EMR along wave guide 314 towards heating portion 306 of receiving chamber 304. EMR source 310 may be capable of varying intensity (e.g., amplitude or frequency) of emitted EMR according to particular materials of wire segments 302, a particular time during which wire segments 302 may be located in EMR exposure region 330, such as based on a temperature increase to cause wire segments 302 to transition to a liquid phase. As discussed above, once the temperature of wire segments 302 increases above the melting point, the wire segments may take a spherical shape, such as due to surface tension. Subsequently, spherical particles 312 may be cooled such as to cause them to transition back to a solid phase while maintaining the spherical shape.

In one example, cooling portion 308 of receiving chamber 304 may comprise a controlled atmosphere. A quenching gas may be present, for example, such as to facilitate a transition for formed spherical particles 312 back to a solid phase from the liquid phase. The transition back to a solid phase may occur while spherical particles 312 fall through cooling portion 308, as indicated by arrow C. The quenching gas may be introduced to receiving chamber 304 via an inlet 320. In one example, cooling spherical particles 312 may collect in a bottom of receiving chamber 304, as shown in FIG. 3. In another example, spherical particles 312 may be directed to another compartment for cooling and/or storage.

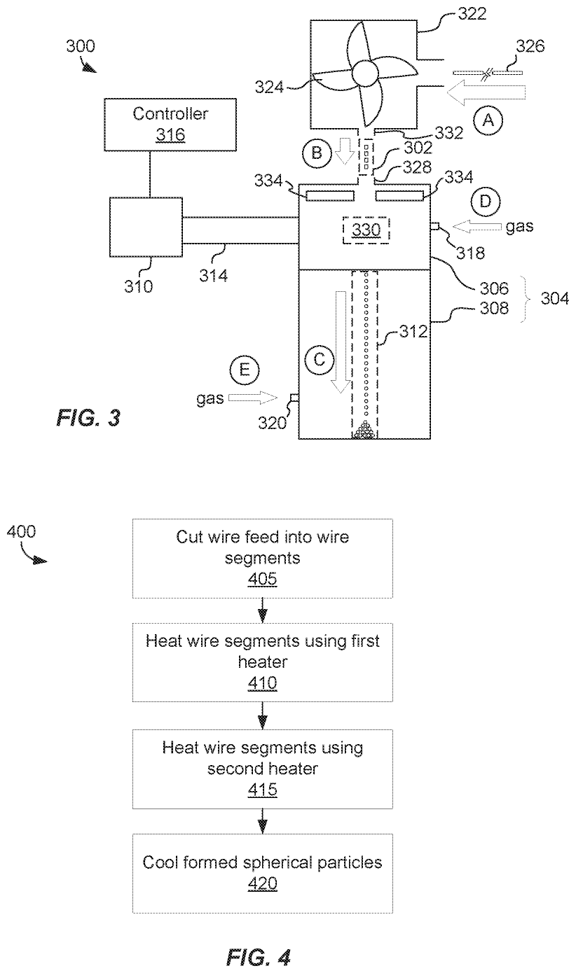

Turning now to FIG. 4, an example method 400 for forming spherical particles is presented referring back to FIG. 3 to provide context. In one example implementation, wire feed 326 may be cut by a cutter 322 in proximity to a receiving chamber 304, such as illustrated in FIG. 3. For instance, wire feed 326 may be fed into a cutter 322 having cutting blades 324, and substantially uniform wire segments 302 (e.g., having a length to diameter ratio of approximately 2:1 or less) may be cut from wire feed 326 by cutter 322, such as illustrated at block 405 of example method 400. The cut wire segments 302 may be fed into a receiving chamber, such as receiving chamber 304 in FIG. 3. One or more heaters (e.g., heating elements 334) may be used in order to heat wire segments 302 above a melting point thereof.

As discussed above, in one example heating elements 334 may raise a temperature of wire segments 302, such as using heating elements arranged in or in proximity to heating portion 306, such as illustrated by block 410 of example method 400. A controlled atmosphere, such as containing an inert gas (e.g., argon or nitrogen), may facilitate the heating of wire segments 302. In one example case, it may be desirable for a heater (e.g., heating elements 334) to raise the temperature of wire segments 302 to a temperature that is lower than the melting point, such as to avoid potentially cumbersome wall sections of heating portion 306. Subsequently, EMR emitting source 310 may be used in order to cause the temperature of wire segments 302 to increase above the melting point, such as shown at block 415 of example method 400.

By way of non-limiting example, EMR source 310 may emit EMR in the microwave spectrum and may be arranged to emit EMR to a particular region or subpart of heating portion 306, such as EMR exposure region 330. The emitted EMR may cause the temperature of wire segments 302 to increase above a melting point and thereby cause wire segments 302 to transition to a liquid. The liquefied wire segments may take a spherical form.

Spherical particles 312 may be cooled in a cooling portion 308 of receiving chamber 304, such as to maintain their spherical form as illustrated by block 420 of example method 400. Cooling portion 308 may have a controlled atmosphere, such as containing a quenching gas (e.g., He or H₂).

In one example, then, forming spherical particles may comprise heating cut wire segments using EMR in the microwave spectrum. The wire segments may be heated above a melting point and transition to a liquid and form spherical particles. The liquid spherical particles may be cooled to transition to a solid phase.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A device comprising:
a receiving chamber to receive wire segments and through which the received wire segments are to travel in a free fall, the receiving chamber comprising:
a heating portion through which the received wire segments are to travel in a free fall and in which the wire segments are to be heated and to form as spherical particles; and
a cooling portion to allow the formed spherical particles to cool; and
a source of electromagnetic radiation (EMR) to emit microwave EMR, the to be emitted microwave EMR to be directed towards wire segments in the heating portion.

2. The device of claim 1, further comprising a wave guide arranged between the source of EMR and the heating portion, the wave guide to direct the to be emitted microwave EMR into the receiving chamber.

3. The device of claim 1, wherein the receiving chamber comprises a controlled atmosphere.

4. The device of claim 3, wherein the controlled atmosphere comprises a reducing or inert gas.

5. The device of claim 4, wherein the reducing or inert gas comprises nitrogen, hydrogen, carbon monoxide, or a combination thereof.

6. The device of claim 3, wherein the controlled atmosphere comprises a quenching or inert gas comprising an argon/hydrogen blend, a nitrogen/hydrogen blend, hydrogen, a helium/hydrogen blend, or a combination thereof.

7. The device of claim 1, further comprising a wire chopper to receive a wire feed and to cut the wire feed into the wire segments to be received at the receiving chamber, wherein the wire chopper comprises blades comprising zirconia, diamond, or tungsten carbide.

8. A method of forming metal particles for a build material, the method comprising:
heating wire segments that travel through a heating portion of a receiving chamber in a free fall, wherein the heating portion comprises a reducing gas;
directing electromagnetic radiation (EMR) at the heated wire segments in the heating portion to form spherical particles; and
cooling the spherical particles in a quenching gas.

9. The method of claim 8, wherein directing the EMR comprises directing the EMR at a desired region of the heating portion to heat the wire segments above a melting point of the wire segments.

10. The method of claim 9, wherein cooling the spherical particles comprises allowing the spherical particles to travel in a free fall from the desired region of the heating portion.

11. The method of claim 8, wherein heating the wire segments comprises heating the wire segments to a temperature below a melting point of the wire segments.

12. The method of claim 8, wherein the spherical particles comprise a substantially uniform diameter.

13. A device for forming spherical particles for a build material, the device comprising:
a wire chopper to receive feed wire and form wire segments of a substantially uniform size, wherein the to be formed wire segments are to be allowed to travel in a free fall through a heating portion comprising heating elements, the heating portion comprising a controlled atmosphere;
a microwave generator arranged to transmit generated microwave electromagnetic radiation (EMR) along a waveguide and into the heating portion, wherein the heating elements arranged in the heating portion are to heat the wire segments to a temperature below the melting point of the feed wire and the generated microwave EMR is to heat the wire segments to a temperature above the melting point of the feed wire to form spherical particles; and
a cooling portion to receive the formed spherical particles and allow the temperature of the formed spherical particles to decrease below the melting point.

14. The device of claim 13, comprising an inlet to allow a gas be transmitted to the heating portion.

15. The device of claim 14, comprising an inlet to allow a second gas to be transmitted to the cooling portion.
